(19) United States
(12) Patent Application Publication
(10) Pub. No.: US 2011/0253178 A1
(43) Pub. Date: Oct. 20, 2011

(54) Glass sheet washing machine

(76) Inventor: Bruno Margaria, Villar San Costanzo (IT)

(21) Appl. No.: 13/086,543

(22) Filed: Apr. 14, 2011

(30) Foreign Application Priority Data
Apr. 14, 2010 (IT) TO2010A 000296

(51) Int. Cl. B08B 11/04; B08B 3/00

(52) U.S. Cl. 134/95.2

(57) ABSTRACT

In a washing machine, a glass sheet arranged on a resting plane is washed and then dried by means of at least one upper drying blowing unit, which is arranged over the sheet, is movable from and to the resting plane, and is connected by means of a tube f variable length to a ventilating unit arranged either over or under the same resting plane.

The present invention relates to a machine for washing glass sheets.

### BACKGROUND OF THE INVENTION

In the field of glass sheet washing, using washing machines is known, which comprise a motorized-roller resting plane on which the sheet to be washed rests and is fed, and between which dispensing nozzles are provided for conveying a detergent liquid onto the sheets, and rotating brush cleaning assemblies operating on the extended surfaces of the sheets. Lower blowing units and upper blowing units adapted to convey respective flows of drying air onto the mentioned extended surfaces are arranged downstream of the cleaning assemblies and of the dispensing nozzles. The lower blowing units are arranged underneath and in a fixed position with respect to the roller surface, while the upper blowing units are carried by a supporting structure facing and overlaying the roller plane. In order to allow the required maintenance and cleaning operations of the machine, the supporting structure, and thus the upper blowing units, are vertically movable with respect to the resting plane between a lowered working position and a raised resting position, in which the structure is spaced apart from the resting plane by an amount so as to allow the roller plane to be accessed, which is normally of the order of 40-60 cm.

Both the upper blowing units and the lower blowing units are fed with respective drying air flows conveyed by corresponding ventilating units.

The position of the ventilating units with respect to the roller plane either characterizes or distinguishes the washing machines which are thus divided into washing machines with inner or lower ventilating units, where the ventilating units are generally arranged under a horizontal plane coinciding with the mentioned roller plane, and washing machines with external ventilating units, i.e. with ventilating units arranged over or outside the mentioned supporting structure, e.g. on dedicated frames or structures.

The ventilating units are connected to the blowing units by means of corrugated hose bundles. The hoses which connect the ventilating units to the upper blowing units should be necessarily kept in excess to allow the movement of the upper blowers to and from the resting plane, implying that when the upper blowers are arranged in the lowered working positions, the tubes inevitably describe tortuous paths forming loops and generating high load loss also due the presence of corrugations. Not only, because the tubes themselves are free-standing, they arbitrarily rest on underlying parts of the machine, thus generating vibrations and annoying acoustic emissions which are added to the acoustic emissions due to the motion of air in the tubes themselves.

In the known machines, such emissions are difficult to mitigate with the common noise-deadening barriers, especially because the tubes should maintain their movement/adaptation freedom with respect to the underlying parts of the machine when translating the upper blowers.

Finally, the corrugated tubes used have different lengths according to where the ventilating units are positioned and according to the dimensional features of the machines, with the consequence that each machine needs its own dedicated version and constructional details.

Furthermore, having tube bundles simply resting on the machines makes the machines poorly satisfactory from the point of view of appearance. Attempts to obviate this problem have been made by accommodating such corrugated tubes into external closing guards or casings which have however the sole result of increasing the dimensions of the machine in an unjustified manner.

### SUMMARY OF THE INVENTION

It is the object of the present invention to provide a machine for washing glass sheets, the constructional features of which allow to solve the above-mentioned problems in a highly simple, cost-effective manner and, in particular, which allow to uniform the versions of the different machine and to greatly abate acoustic emissions, thus increasing the appearance of the machines themselves.

According to the present invention, a glass sheet washing machine is provided comprising a sheet resting plane, means for washing the opposite extended surfaces of the sheets arranged on the resting plane, at least one drying blowing unit arranged above said resting plane to convey a drying air flow towards said sheet, actuating means to translate said blowing unit to and from said resting plane, at least one ventilating unit to convey a drying air mass towards said blowing unit and arranged above or below a lying plane of said resting plane, a tubing to connect said blowing unit to said ventilating unit, characterized in that said tubing has a variable length.

In the above-described machine, said tubing preferably comprises a telescopic joint having a movable outlet tight-fluidly coupled to said blowing unit to be displaced together with the blowing unit and an inlet tight-fluidly connected to said ventilating unit.

Conveniently, said inlet is arranged in a fixed position below said lying or resting planes.

### BRIEF DESCRIPTION OF THE DRAWINGS

The invention will now be described with reference to the accompanying drawings which show non-limitative embodiments thereof, in which:

FIGS. 1 and 2 are diagrammatic perspective side views of a first preferred embodiment of the washing machine according to the present invention, arranged in two different functional positions;

FIG. 3 diagrammatically shows the machine in FIG. 2 with parts removed for clarity;

FIG. 4 is similar to FIG. 3 and shows a second preferred embodiment of the washing machine according to the present invention; and

FIG. 5 shows a detail of figures from 1 to 4, on a highly enlarged scale.

### DETAILED DESCRIPTION OF THE INVENTION

In figures from 1 to 3, numeral 1 indicates as a whole a washing machine for cleaning a glass sheet 2.

Machine 1 comprises a base 3, a motorized-roller resting plane 4 for supporting and feeding sheet 2, a brush cleaning assembly 5, known per se and not described in detail, to wash the opposite extended surface of sheet 2, and an air drying assembly 6.

In the particular example described, the air drying assembly 6 comprises a pair of lower blowing units 8, known per se and not described in detail, each of which is arranged in a fixed position under the roller plane 4, and a pair of upper blowing units 9 arranged side-by-side over and in a position facing the resting plane 4.

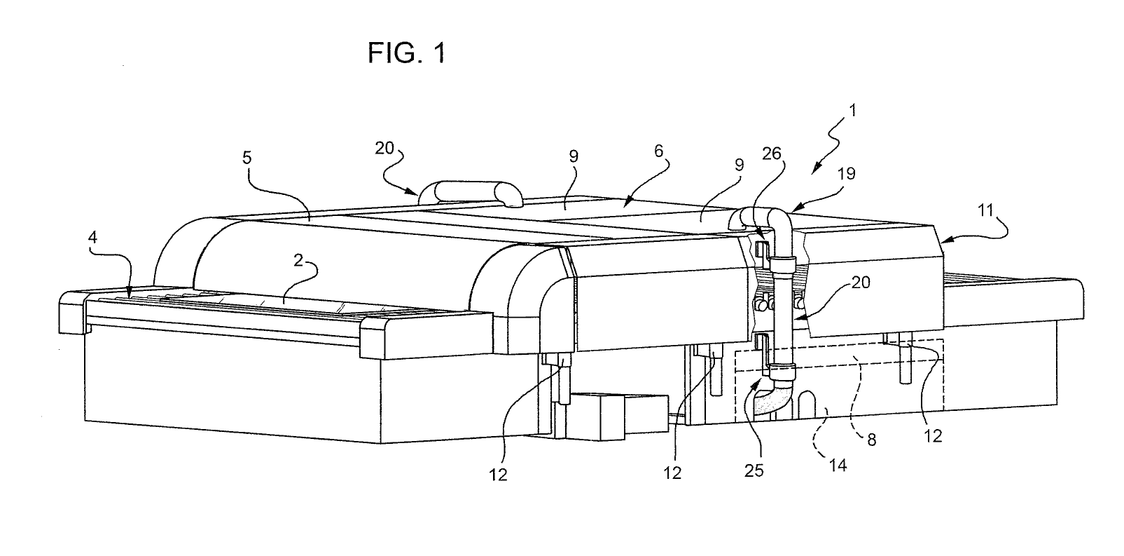

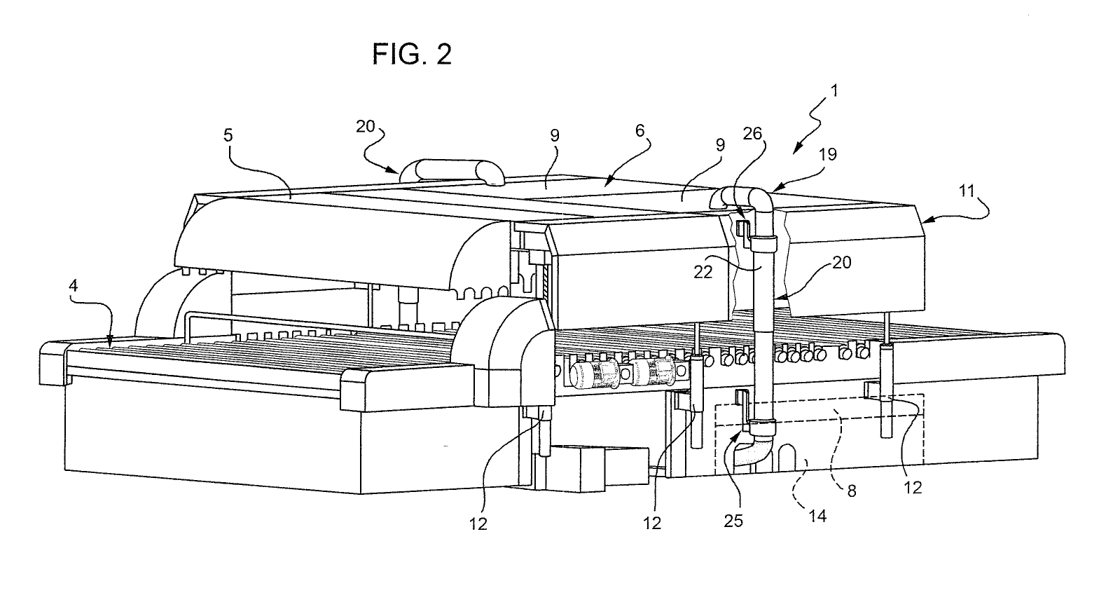

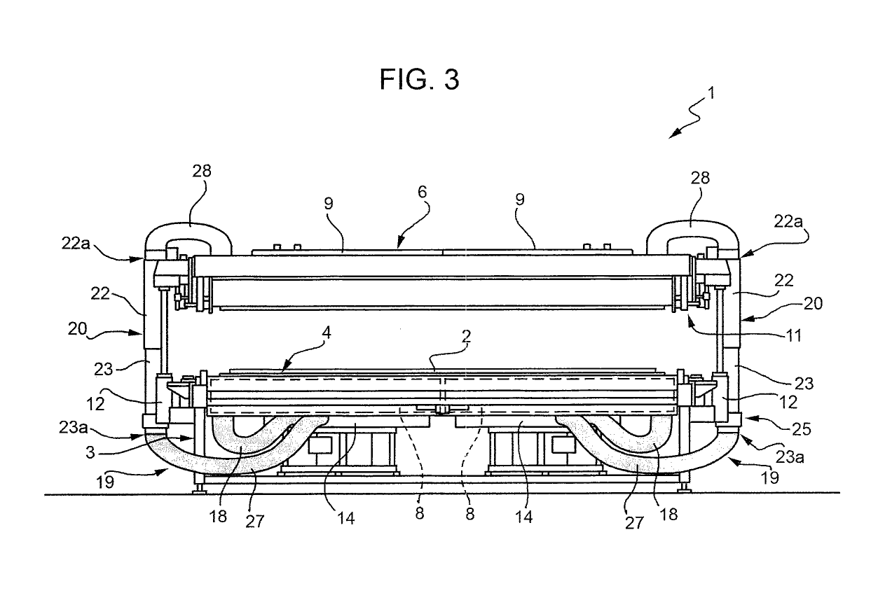

Each of the upper blowing units 9 and part of the cleaning assembly 5 are carried by a common supporting structure 11, which is movable under the bias of a linear actuators 12 in a direction orthogonal to the supporting plane 4 for moving the upper blowing units 9 between a lowered operating position, shown in FIG. 1, and a raised resting position, shown in FIGS. 2 and 3, in which the upper blowing units 9 themselves are spaced apart from the supporting plane 4 by a variable amount, from forty to sixty centimeters, and in all cases such to allow operations of cleaning and maintaining machine 1.

Again with reference to figures from 1 to 3, the drying assembly 6 further comprises, for each pair of reciprocally overlaying blowing units 8,9, a corresponding ventilating unit 14 for conveying a mass of drying air to the corresponding mentioned pair of blowing units 8,9. In the particular example described, each ventilating unit 14 is arranged under the roller plane 4, i.e. within base 3 of machine 1, and is fluid-tightly connected to the corresponding lower blowing unit 8 by means of a hose 18 and to the upper blowing unit 9 by means of a tubing or pipe 19 of variable length.

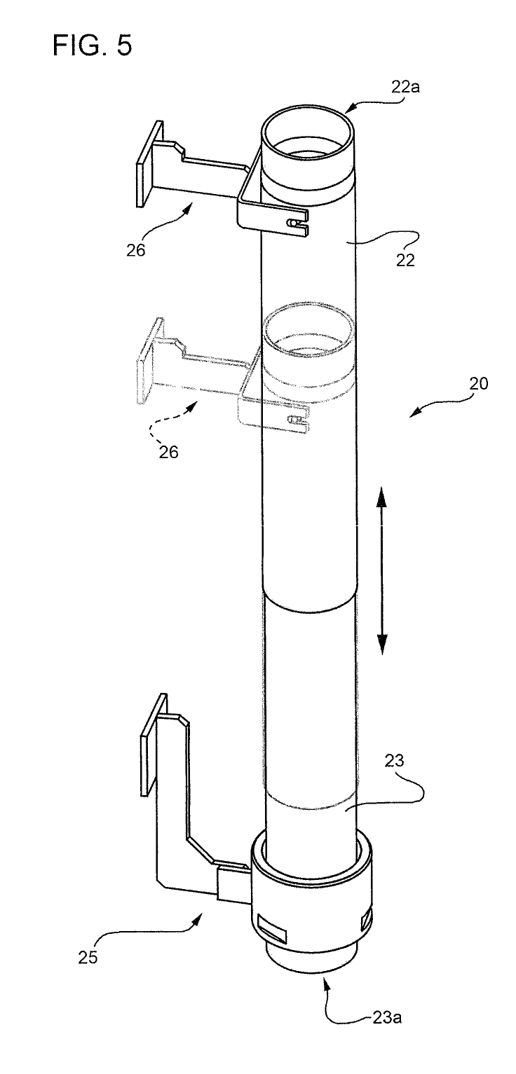

With reference to the accompanying figures and, in particular, to FIG. 5, each pipe 19 comprises an intermediate telescopic joint 20, in turn comprising two portions 22 and 23 fluid-tightly coupled to each other in a sliding manner with respect to each other in a vertical direction orthogonal to plane 4, and in which portion 23 is integrally connected to base 3 by means of a bracket 25, while portion 22 is coupled to structure 11 by means of a fork device 26.

Each telescopic joint 20 has a fixed inlet 23a, which is arranged underneath plane 4 and, conveniently close to a resting surface of machine 1, and is connected to an outlet of the corresponding ventilating unit 14 by means of a smooth or corrugated tube 27. The outlets 22a of each telescopic joint 20 are instead arranged over structure 11 and are each connected to an inlet mouth of the corresponding upper blowing unit 9 by means of a corresponding upside-down U-shaped pipe 28, conveniently of flexible type, as shown in FIG. 3.

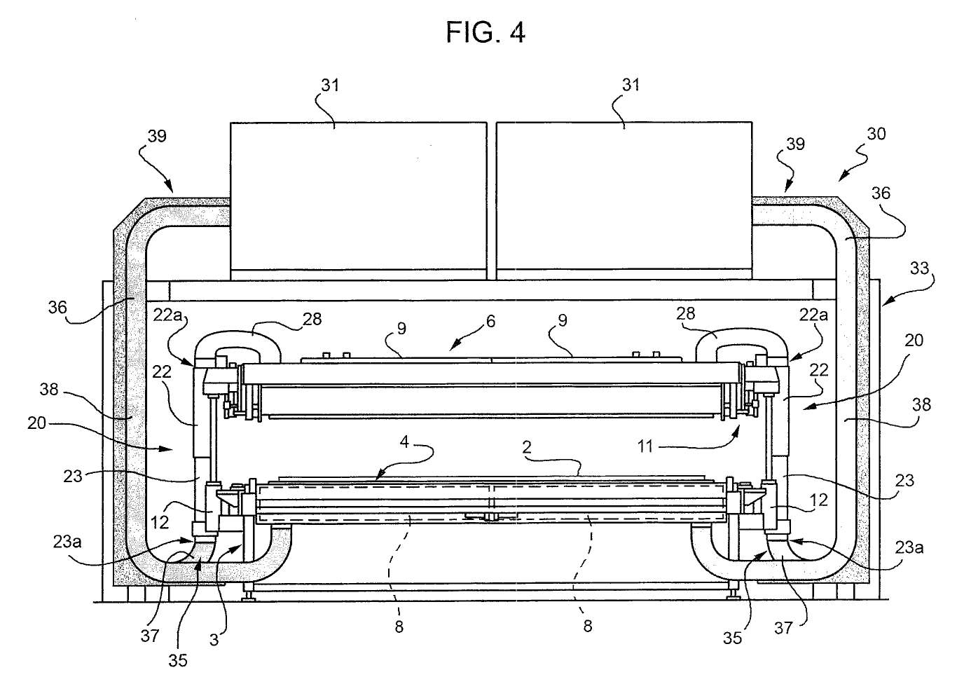

The variant shown in FIG. 4 relates to a washing machine 30, which differs from machine 1 for some manufacturing details and the constituent parts of which are distinguished, where possible, by the same reference numbers as the corresponding parts of machine 1.

In machine 30, the ventilating units 14 inside machine 1 are replaced by respective external or upper units 31, which are arranged over the structure 11 and the upper blowing units 9 themselves, and are conveniently supported by a gantry-like structure 33.

Each upper blowing unit 31 is connected to the corresponding lower blowing unit 8 by means of a tube 36 and to the upper blowing unit 9 by means of a pipe 35 of variable length. Pipe 35 comprises a conveniently smooth, fixed tube 37 to connect the outlet mount of the ventilating unit 31 to the inlet 23a of the telescopic joint 20 itself, in addition to the corresponding joint 20. Both tubes 36 and 37 have respective curved terminal ends and respective intermediate rectilinear segments 38 arranged side-by-side and all blocked in a fixed position with respect to base 3 and accommodated in an external, shaped soundproofed casing or guard 39.

From the above, it is apparent that, as compared to the known solutions, the presence of telescopic joints 20 allows, regardless of the machine type, i.e. regardless of the arrangement of the ventilating units, to eliminate all the free-standing air-conveying hoses by defining paths with a fixed, unvarying curvature. Specifically, using telescopic joints avoids the presence of arbitrarily resting segments and the consequent formation of arbitrary, tortuous paths in each of the drying-air conveying tubes.

As compared to the existing solutions, the absence of loops or sudden direction changes considerably reduces localized losses, while the smooth inner walls of both the joints and the remaining parts of the tube considerably limit the spread load losses.

The absence of curvature variability of the tubes following the movement of the upper blowers and the consequent possibility of connecting the different segments of the same tube directly to the structure of the machine allow, on one hand, the onset of vibratory states and of annoying acoustic emissions to be inhibited and, on the other, soundproofing barriers to be simply and cost-effectively provided, which are not only effective but with shape and size which may be chosen so as to make the machine pleasant also from the appearance point of view of.

Finally, with regards to the arrangement of the joints, and in particular to the fact of including inlets of the joint themselves underneath the resting plane and preferably close to the floor, this allows the tube bundles connecting the upper blowing units to the corresponding ventilating units to be simplified regardless of the position of the ventilating units themselves, and specifically the versions of the two types of machines to be uniformed. Indeed, the outlets of the ventilating units are always connected to the inlets of the telescopic joint regardless of whether the blowing units are arranged under or over the resting plane 4, and in either case by means of simple fixed tube segments which never vary their position neither during the machine operation nor during the usual maintenance operations.

From the above, it is apparent that changes and variants may be made to the above-described machines 1 and 30 and, in particular, the telescopic joints 20 may be made differently from that described by way of example and/or arranged in positions different from those shown, as different could be the ventilating units 14 and 31.

Again with regards to the ventilating units 14,31 those could be arranged in different positions from those shown by way of example. In particular, both units 14 and units 31 could be arranged on specific structures/bases arranged by the side of the washing machine, i.e. outside the roller resting plane 4, and generally under or over a horizontal lying plane of the roller resting plane.

Furthermore, units 14 could be arranged under the floor plane on which the machine structure rests, while the ventilating units 41 could be arranged on specific structures, in turn arranged on platforms, also spaced apart from the resting plane, of the plant in which the machine works.

1. A glass sheet washing machine comprising a resting plane for the sheets, washing means for washing the opposite extended surfaces of the sheets arranged on the resting plane, at least one drying blowing unit arranged above said resting plane to convey a drying air flow towards said sheet, actuating means to translate said blowing unit from and towards said resting plane, at least one ventilating unit to convey a drying air mass towards said blowing unit and arranged above or below a lying plane of said resting plane, a connection pipe of said blowing unit to said ventilating unit, characterized in that said pipe has a variable length.

2. The machine according to claim 1, characterized in that said pipe comprises a telescopic joint having a mobile outlet fluid-tightly coupled to said blowing unit to be displaced together with the blowing unit and an inlet fluid-tightly connected to said ventilating unit.

3. The machine according to claim 2, characterized in that said inlet is arranged below said lying plane or resting plane.

4. The machine according to claim 2, characterized in that said inlet is arranged in a fixed position with respect to said resting plane.

5. The machine according to claim 1, characterized in that said telescopic joint comprises two smooth portions fluid-tightly sliding one with respect to another in a direction substantially orthogonal to said resting plane.

6. The machine according to claim 2, characterized in that said telescopic joint extends in a position facing a side of said machine.

7. The machine according to claim 1, characterized in that said pipe comprises at least one fixed segment and in that sound-proofing means surround at least part of said pipe.
